(19) United States
(12) Patent Application Publication
(10) Pub. No.: US 2013/0154952 A1
(43) Pub. Date: Jun. 20, 2013

(54) GESTURE COMBINING MULTI-TOUCH AND MOVEMENT

(71) Applicants: Kenneth P. Hinckley, Redmond, WA (US); Hyunyoung Song, New York, NY (US)

(72) Inventors: Kenneth P. Hinckley, Redmond, WA (US); Hyunyoung Song, New York, NY (US)

(73) Assignee: MICROSOFT CORPORATION, Redmond, WA (US)

(21) Appl. No.: 13/327,794

(22) Filed: Dec. 16, 2011

(51) Int. Cl. G06F 3/041

(52) U.S. Cl. 345/173

(57) ABSTRACT

Functionality is described herein for interpreting gestures made by a user in the course of interacting with a handheld computing device. The functionality operates by: (a) receiving a touch input event from at least one touch input mechanism; (b) receiving a movement input event from at least one movement input mechanism in response to movement of the computing device; and (c) determining whether the touch input event and the movement input event indicate that a user has made a multi-touch-movement (MTM) gesture. A user performs a MTM gesture by touching a surface of the touch input mechanism to establish two or more contacts in conjunction with moving the computing device in a prescribed manner. The functionality can define an action space in response to the MTM gesture and perform an action which affects the action space.

### BACKGROUND

A handheld computing device (such as a smartphone) commonly allows users to make various gestures by touching the surface of the device's touchscreen in a prescribed manner. For example, a user can instruct the handheld computing device to execute a panning operation by touching the surface of the touchscreen with a single finger and then dragging that finger across the surface of the touchscreen surface. In another case, a user can instruct the handheld computing device to perform a zooming operation by touching the surface of the touchscreen with two fingers and then moving the fingers closer together or farther apart.

To provide a robust user interface, a developer may wish to expand the number of gestures that the handheld computing device is able to recognize. However, a developer may find that the design space of available gestures is limited. Hence, the developer may find it difficult to formulate a gesture that is suitably distinct from existing gestures. The developer may create an idiosyncratic and complex gesture to distinguish over existing gestures. But an end user may have trouble remembering and executing such a gesture.

### SUMMARY

Functionality is described herein for interpreting gestures made by a user in the course of interacting with a handheld computing device. The functionality operates by: receiving a touch input event from at least one touch input mechanism in response to the user making contact with a surface of the computing device; receiving a movement input event from at least one movement input mechanism in response to movement of the computing device; determining whether the touch input event and the movement input event indicate that a user has made a multi-touch-movement (MTM) gesture. A user performs a MTM gesture by touching a surface of the touch input mechanism to establish two or more contacts, in conjunction with moving the computing device in a prescribed manner. The functionality defines an action space in response to the determining operation, where the two or more contacts demarcate the action space. The functionality may then perform an operation that affects the action space.

For example, a user may perform an MTM gesture by applying at least two fingers to a display surface of a touchscreen interface mechanism. The user may then tilt the computing device from a starting position in a telltale manner, while maintaining his or fingers on the display surface of the touchscreen interface mechanism. Upon receiving input events which describes these actions, the functionality can conclude that the user has performed a MTM gesture. For example, the functionality can define an action space that is demarcated by the user's two fingers on the display surface. The functionality can then perform any action associated with the MTM gesture, such as by selecting an object encompassed by the action space that has been demarcated by the user with his or her finger.

According to another illustrative aspect, the functionality can detect different types of MTM gestures based on the manner in which the user touches the display surface (and/or other surface(s)) of the computing device.

According to another illustrative aspect, the functionality can detect different types of MTM gestures based on a type of movement executed by the user, while touching the display surface (and/or other surface(s)) of the computing device.

According to another illustrative aspect, the functionality can classify a user's gesture as a MTM gesture even though the user's fingers may have slipped on the display surface of the computing device in the course moving the computing device. The functionality performs this operation by determining whether any finger displacement that occurs during the movement of the device is below a prescribed threshold.

According to another illustrative aspect, the functionality can distinguish between MTM gestures and large movements performed by the user while handling the computing device for non-input-related purposes. For example, the functionality can distinguish between MTM gestures and movements produced when the user picks up and sets down the computing device.

The above approach can be manifested in various types of systems, components, methods, computer readable storage media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative computing device that includes functionality for interpreting touch input events in the context of movement input events.

FIG. 2 shows an illustrative interpretation and behavior selection module (IBSM) used in the computing device of FIG. 1.

FIGS. 3-6 illustrate a series of actions that a user can make to execute a multi-touch-movement (MTM) gesture. In this particular example, the user makes the MTM gesture after performing a preliminary zooming gesture.

FIGS. 7-13 illustrate alternative ways (compared to the example of FIGS. 3-6) that a user can perform a MTM gesture.

FIG. 14 shows an illustrative procedure that explains one manner of operation of the IBSM of FIGS. 1 and 2.

FIG. 15 shows an illustrative procedure that sets forth additional details regarding analysis performed by the IBSM.

FIG. 16 shows an illustrative procedure that explains one manner in which the IBSM can detect MTM gestures that are seamlessly interleaved with one or more other gestures.

FIG. 17 shows illustrative computing functionality that can be used to implement any aspect of the features shown in the foregoing drawings.

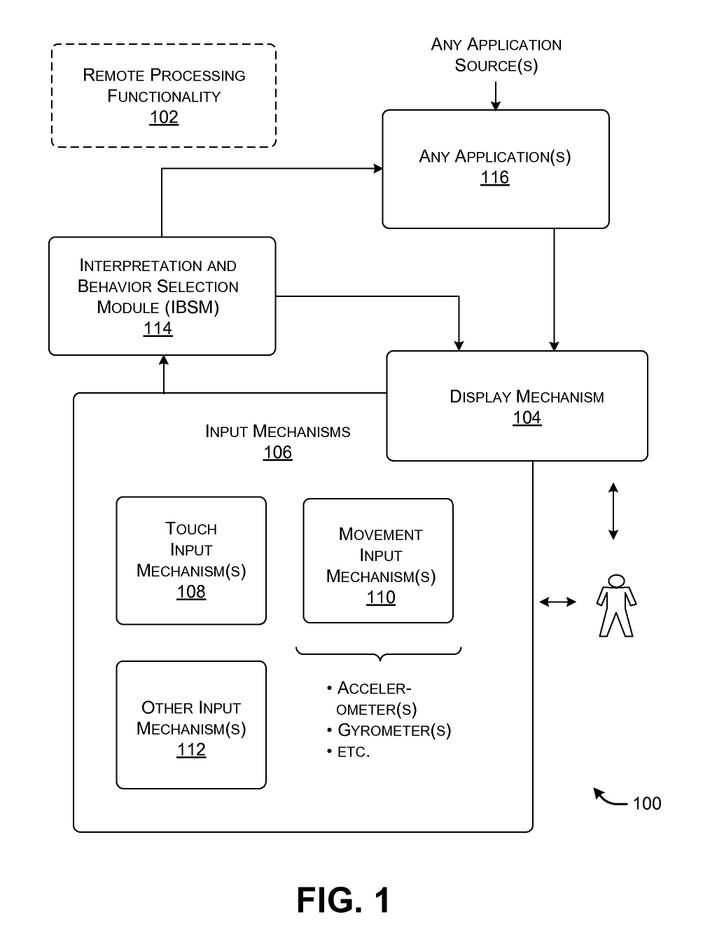

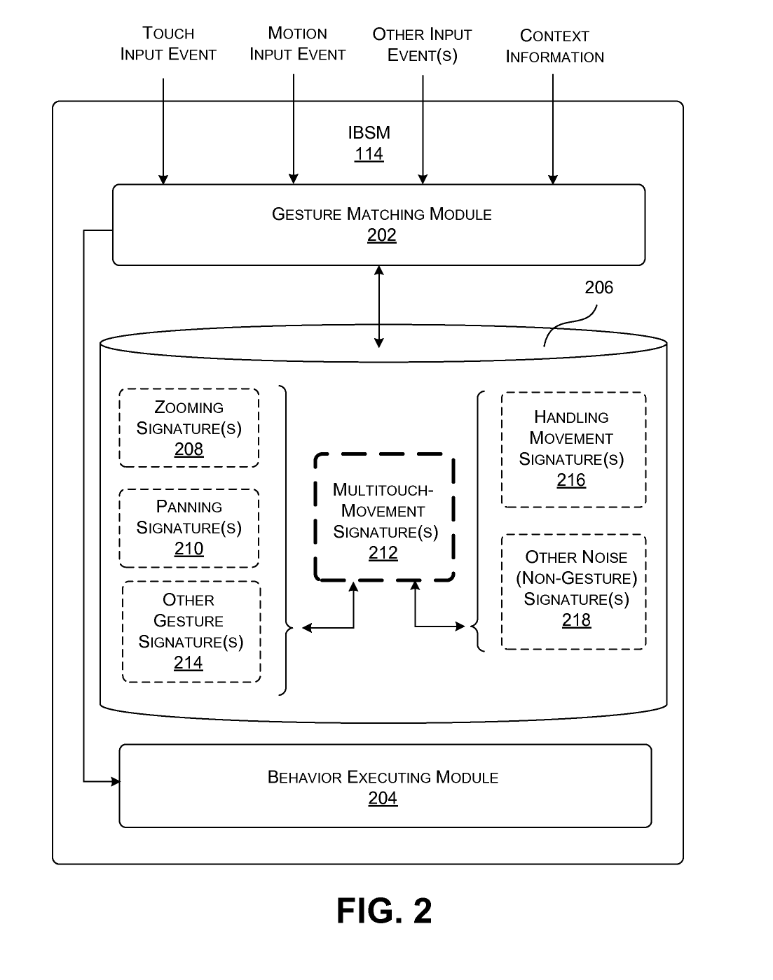

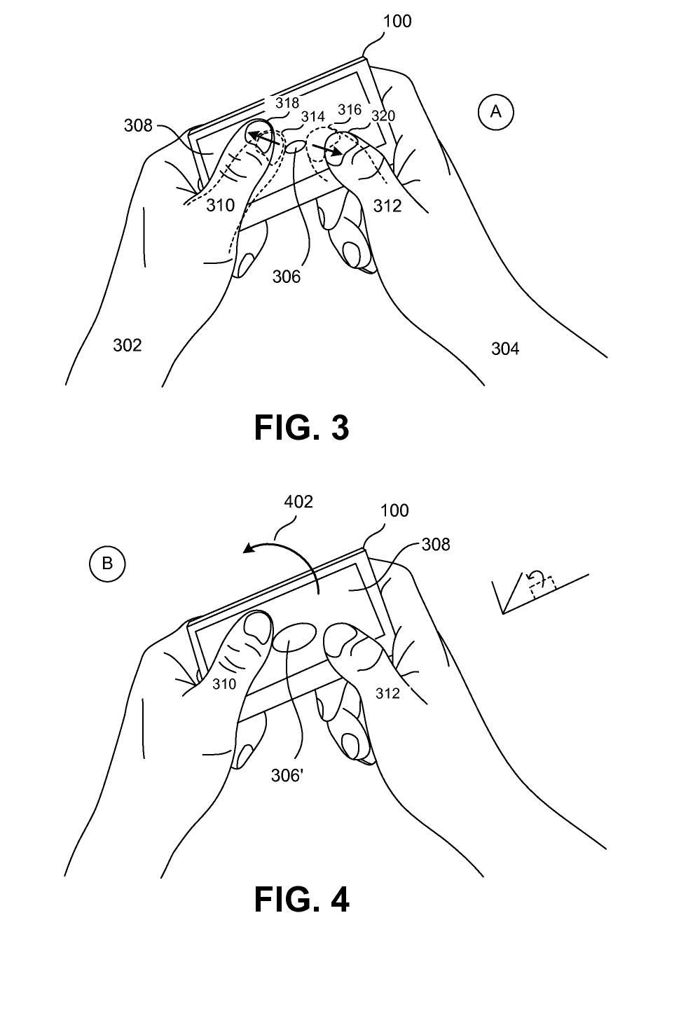

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes illustrative functionality for interpreting gestures made by a user in the course of interacting with a handheld computing device, including multi-touch-movement gestures which involve simultaneously touching and moving the computing device. Section B describes illustrative methods which explain the operation of the functionality of Section A. Section C describes illustrative computing functionality that can be used to implement any aspect of the features described in Sections A and B.

This application is related to commonly-assigned patent application Ser. No. 12/970,939, entitled, “Detecting Gestures Involving Intentional Movement of a Computing Device,” naming the inventors of Kenneth Hinckley, et al., filed on Dec. 17, 2010.

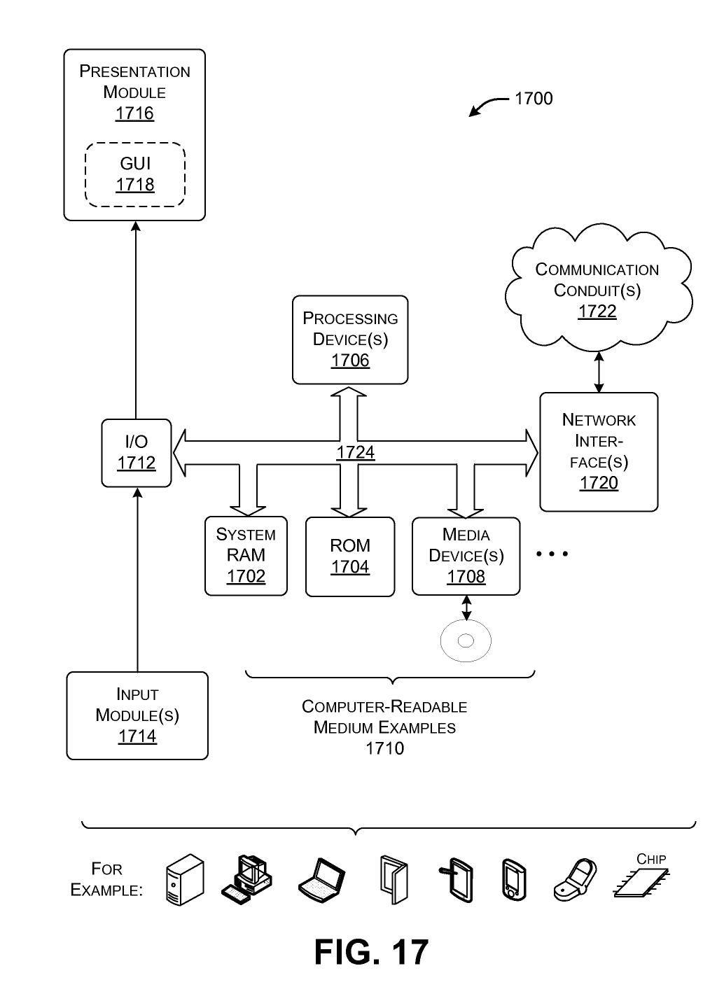

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software, hardware (e.g., chip-implemented logic functionality), firmware, etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 17, to be discussed in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software, hardware (e.g., chip-implemented logic functionality), firmware, etc., and/or any combination thereof.

As to terminology, the phrase “configured to” encompasses any way that any kind of physical and tangible functionality can be constructed to perform an identified operation. The functionality can be configured to perform an operation using, for instance, software, hardware (e.g., chip-implemented logic functionality), firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware (e.g., chip-implemented logic functionality), firmware, etc., and/or any combination thereof. When implemented by a computing system, a logic component represents an electrical component that is a physical part of the computing system, however implemented.

The phrase “means for” in the claims, if used, is intended to invoke the provisions of 35 U.S.C. §112, sixth paragraph. No other language, other than this specific phrase, is intended to invoke the provisions of that portion of the statute.

The following explanation may identify one or more features as “optional.” This type of statement is not to be interpreted as an exhaustive indication of features that may be considered optional; that is, other features can be considered as optional, although not expressly identified in the text. Finally, the terms “exemplary” or “illustrative” refer to one implementation among potentially many implementations

A. Illustrative Mobile Device and its Environment of Use

FIG. 1 shows an illustrative computing device 100 on which a user can perform gestures. The computing device 100 corresponds to a portable device that the user can hold with one or more hands. For example, without limitation, the computing device 100 can correspond to a smartphone, an electronic book reader device, a portable digital assistant device, a tablet-type or slate-type computing device, a portable game console device, a laptop computing device, a netbook-type computing device, and so on.

In one implementation, all of the gesture-recognition functionality described herein is implemented on the computing device 100. Alternatively, at least some aspects of the gesture-recognition functionality can be implemented by remote processing functionality 102. The remote processing functionality 102 may correspond to one or more server computers and associated data stores, provided at a single site or distributed over plural sites. The computing device 100 can interact with the remote processing functionality 102 via one or more networks, such as the Internet. However, to simplify and facilitate explanation, it will henceforth be assumed that the computing device 100 performs all aspects of the gesture-recognition functionality.

The computing device 100 includes a display mechanism 104 and various input mechanisms 106. The display mechanism 104 provides a visual rendering of digital information on a display surface of the computing device 100. The display mechanism 104 can be implemented by any type of display, such as a liquid crystal display, etc. Although not shown, the computing device 100 can also include other types of output mechanisms, such as an audio output mechanism, a haptic (e.g., vibratory) output mechanism, etc.

The input mechanisms 106 receive input events supplied by any source or combination of sources. In one case, the input mechanisms 106 provide input events in response to input actions performed by a user. According to the terminology used herein, an input event itself corresponds to any instance of input information having any composition and duration.

The input mechanisms 106 can include at least one touch input mechanism 108 which receives touch input events from the user when the user makes contact with at least one surface of the computing device 100. For example, in one case, the touch input mechanism 108 can correspond to a touchscreen interface mechanism which receives input events when it detects that a user has touched a display surface of the touchscreen interface mechanism. This type of touch input mechanism can be implemented using any technology, such as resistive touch screen technology, capacitive touch screen technology, acoustic touch screen technology, bi-directional touch screen technology, and so on. In bi-directional touch screen technology, a display mechanism provides elements devoted to displaying information and elements devoted to receiving information. Thus, a surface of a bi-directional display mechanism is also a capture mechanism.

In the examples presented herein, the user may interact with the touch input mechanism 108 by physically touching a display surface of the computing device 100. However, the touch input mechanism 108 can also be configured to detect when the user has made contact with any other surface of the computing device 100, such as the back of the computing device 100 and/or the sides of the computing device 100. In addition, in some cases, a user can be said to make contact with a surface of the computing device 100 when he or she draws close to a surface of the computing device, without actually physically touching the surface. Among other technologies, the bi-direction touch screen technology described above can accomplish the task of detecting when the user moves his or her hand close to a display surface, without actually touching it. A user may contact a surface of the computing device 100 with one or more fingers (for instance). In this disclosure, a thumb is considered as one type of finger.

Alternatively, or in addition, the touch input mechanism 108 can correspond to a pen input mechanism whereby a user makes physical or close contact with a surface of the computing device 100 with a stylus or other implement (besides, or in addition to, the user's fingers). However, to facilitate description, the explanation will henceforth assume that the user interacts with the touch input mechanism 108 by physically touching its surface.

FIG. 1 depicts the input mechanisms 106 as partially overlapping the display mechanism 104. This is because at least some of the input mechanisms 106 may be integrated with functionality associated with the display mechanism 104. This is the case, for example, with respect to a touch interface mechanism because the display surface of this device is used to both display information and receive input events.

The input mechanisms 106 also include at least one movement input mechanism 110 for supplying movement input events that describe movement of the computing device 100. That is, the movement input mechanism 110 corresponds to any type of input mechanism that measures the orientation or motion of the computing device 100, or both. For instance, the movement input mechanism 110 can be implemented using accelerometers, gyroscopes, magnetometers, vibratory sensors, torque sensors, strain gauges, flex sensors, optical encoder mechanisms, and so on. Some of these devices operate by detecting specific postures or movements of the computing device 100 or parts of the computing device 100 relative to gravity. Any movement input mechanism 110 can sense movement along any number of spatial axes. For example, the computing device 100 can incorporate an accelerometer and/or a gyroscope that measures movement along three spatial axes.

FIG. 1 also indicates that the input mechanisms 106 can include any other input mechanisms 112. Illustrative other input mechanisms can include one or more image sensing input mechanisms, such as a video capture input mechanism, a depth sensing input mechanism, a stereo image capture mechanism, and so on. Some of the image sensing input mechanisms can also function as movement input mechanisms, insofar as they can be used to determine movement of the computing device 100 relative to the surrounding environment. Other input mechanisms can include a keypad input mechanism, a joystick mechanism, a mouse input mechanism, a voice input mechanism, and so on.

In some cases, the input mechanisms 106 may represent components that are integral parts of the computing device 100. For example, the input mechanisms 106 may represent components that are enclosed in or disposed on a housing associated with the computing device 100. In other cases, at least some of the input mechanisms 106 may represent functionality that is not physically integrated with the display mechanism 104. For example, at least some of the input mechanisms 106 can represent components that are coupled to the computing device 100 via a communication conduit of any type (e.g., a cable). For example, one type of touch input mechanism 108 may correspond to a pad-type input mechanism that is separate from (or at least partially separate from) the display mechanism 104. A pad-type input mechanism is also referred to as a tablet, a digitizer, a graphics pad, etc.

An interpretation and behavior selection module (IBSM) 114 performs the task of interpreting the input events. In particular, the IBSM 114 receives at least touch input events from the touch input mechanism 108 and movement input events from the touch movement input mechanism 110. Based on these input events, the IBSM 114 determines whether the user has made a recognizable gesture. If a gesture is detected, the IBSM executes behavior associated with that gesture. FIG. 2 provides additional details regarding one implementation of the IBSM 114.

Finally, the computing device 100 may run at least one application 116 that performs any high-level and/or low-level function in any application domain. In one case, the application 116 represents functionality that is stored on a local store provided by the computing device 100. For instance, the user may download the application 116 from a remote marketplace system or the like. The user may then run the application 116 using the local computing resources of the computing device 100. Alternatively, or in addition, a remote system can store at least parts of the application 116. In this case, the user can execute the application 116 by instructing the remote system to run it.

In one case, the IBSM 114 represents a separate component with respect to application 116 that both recognizes a gesture and performs whatever behavior is associated with the gesture. In another case, one or more functions attributed to the IBSM 114 can be performed by the application 116. For example, in one implementation, the IBSM 114 can interpret a gesture that has been performed, while the application 116 can select and execute behavior associated with the detected gesture. Accordingly, the concept of the IBSM 114 is to be interpreted liberally herein as encompassing functions that can be performed by any number of components within a particular implementation.

FIG. 2 shows one implementation of the IBSM 114. The IBSM 114 can include a gesture matching module 202 for receiving various input events. The input events can include touch input events from the touch input mechanism 108, movement input events from the movement input mechanism 110, and any other input events from any other input mechanisms 112. The input events can also include context information which indicates a context in which a user is currently using the computing device 100. For example, the context information can identify the application that the user is running at the present time. Alternatively, or in addition, the context information can describe the physical environment in which the user is using the computing device 100, and so on.

The gesture matching module 202 compares the input events with a collection of signatures that describe different telltale ways that a user may interact with the computing device 100. More specifically, a signature may provide any descriptive information which characterizes the touch input events and/or motion input events that are typically produced when a user makes a particular kind of gesture. For example, a signature may indicate that a gesture X is characterized by a pattern of observations A, B, and C. Hence, if the gesture matching module 202 determines that the observations A, B, and C are present in the input events at a particular time, it can conclude that the user has performed (or is currently performing) gesture X. In some cases, a signature may be defined, at least in part, with reference to one or more other signatures. For example, a particular signature may indicate that a gesture has been performed if observations A, B, and C are present, but providing that there is no match with respect to some other signature (e.g., a noise signature).

A behavior executing module 204 then executes whatever behavior is associated with a matching gesture. More specifically, in a first case, the behavior executing module 204 executes a behavior at the completion of a gesture. In a second case, the behavior executing module 204 executes a behavior over the course of the gesture, starting from that point in time that it recognizes that the telltale gesture is being performed.

The IBSM 114 can provide a plurality of signatures in a data store 206. As stated above, each signature describes a different way that the user can interact with the computing device 100. For instance, the signatures may include at least one zooming signature 208 that describes touch input events associated with a zooming gesture made by a user. For example, the zooming signature 208 may indicate that a user makes a zooming gesture when he or she places two fingers on the display surface of the touch input mechanism 108 and moves the finger together or apart, while maintaining contact with the display surface. The data store 206 may store several of such zooming signatures in the case in which the IBSM 114 allows the user to communicate a zooming instruction in different ways, corresponding to different zooming gestures.

The signatures can also include at least one panning signature 210. The panning signature 210 may indicate that a user makes a panning gesture when he or she places at least one finger on the display surface of the touch input mechanism 108 and moves that finger across the display surface. The data store 206 may store several of such panning signatures in the case in which the IBSM 114 allows the user to communicate a panning instruction in different ways, corresponding to different panning gestures.

The signatures can also include at least one multi-touch-movement (MTM) signature 212, which is the primary focus of the present disclosure. The MTM signature indicates that the user makes an MTM gesture by applying two or more fingers to the display surface of the touch input mechanism 108 while simultaneously moving the computing device 100 in a prescribed manner. In one of the examples set forth below, for instance, the MTM signature indicates that the user makes a particular kind of MTM signature by using two or more fingers to demarcate an action space on the display surface of the touch input mechanism 108; the user then rapidly tilts the computing device 100 about at least one axis while maintaining his or her fingers on the display surface. This has the effect of selecting at least one object encompassed or otherwise associated with the action space.

More generally, the data store 206 can store plural MTM signatures associated with different MTM gestures. Each MTM gesture is characterized by a different combination of input events and movement events. Further, each MTM gesture may invoke a different behavior. However, in some cases, two or more distinct MTM gestures can also be associated with the same behavior. In this scenario, the IBSM 114 allows the user to invoke the same behavior using two or more different gestures.

FIG. 2 also indicates that the signatures can include other non-MTM gesture signatures 214, e.g., besides the zooming signature 208 and the panning signature 210. As used herein, a non-MTM gesture corresponds to a gesture that is not classified as a MTM gesture because it is not defined with respect to a combination of input events and movement events. One such additional non-MTM gesture is a scrolling gesture. A user makes a scrolling gesture by applying one or more fingers to a scrollable region on the surface of the touch input mechanism 108 and then dragging the finger(s) across the surface.

FIG. 2 also indicates that the signatures can include noise signatures that represent telltale ways that a user may interact with the computing device 100 that do not correspond to any gesture (e.g., either non-MTM gestures or MTM gestures) per se. The IBSM 114 uses these signatures to properly detect when the user has performed a gesture, as opposed to some action that the user may have made with no gesture-related intent.

For example, the noise signatures include a handling movement signature 216 and one or more other noise signatures 218. The handling movement signature 216 describes large dramatic movements of the computing device 100, as when the user picks up the computing device 100 or sets it down. More specifically, the handling movement signature 216 can describe such large movements as any movement which exceeds one or more movement-related thresholds. In some cases, the handling movement can be defined on the sole basis of the magnitude of the motion. In addition, or alternatively, the handling movement can be defined with respect to the particular path that the computing device 100 takes while being moved, e.g., as in a telltale manner in which a user may sweep and/or tumble the computing device 100 when picking it up or putting it down (e.g., by removing it from a pocket or bag, or placing it in a pocket or bag, etc.).

In some cases, a MTM signature may be defined, at least in part, with respect to one or more noise signatures. For example, in one case, the MTM signature can indicate that the user has made a MTM gesture if: (a) the user touches the surface of the touch input mechanism 108 in a prescribed manner; (b) the user moves the computing device 100 in a prescribed manner; and (c) the movement (and/or contact) input events do not also match the handling movement signature 216. Hence, in this scenario, if the IBSM 114 detects that such a handling movement signature 216 is present, it can conclude that the user has not performed the MTM gesture in question, even if the user has also touched the surface of the computing device 100 with two or more fingers in the course of moving the computing device 100.

In addition, or alternatively, a MTM signature may be defined with respect to one or more noise signatures that, if present, will not disqualify the conclusion that the user has performed a MTM gesture. For example, one particular noise gesture may indicate that the user has slowly slid his or her fingers across the surface of the computing device 100 by a small amount in the course of moving the computing device 100. The MTM signature can specify that this type of movement, if present, is consistent with the execution of the MTM gesture in question.

In addition, or alternatively, FIG. 2 indicates that any MTM signature can be defined with reference to one or more non-MTM gestures. For example, a MTM gesture may indicate that a particular MTM gesture has not been performed if the input events also match a particular non-MTM gesture.

The examples set forth above are to be construed as representative, rather than limiting or exhaustive. Other implementations can define MTM gestures using any combination of environment-specific considerations. Further, FIG. 2 enumerates different classes of distinct signatures to facilitate description. But any implementation can combine signatures together in any manner. For example, a MTM signature can incorporate, as an integral part thereof, a description of the noise signature that is permitted (and/or not permitted) when making the MTM gesture, rather than making reference to a separate noise signature.

The gesture matching module 202 can compare input events to the signatures in any implementation-specific manner. In some cases, the gesture matching module 202 can filter the input events with respect to one or more noise signatures to provide a noise determination conclusion (such as a handling input event which indicates that the user has handled the computing device 100 without any gesture-related intent). The gesture matching module 202 can then determine whether the input events also match a MTM signature based, in part, on the noise determination conclusion. In the case that the noise is permissible with respect to a particular MTM gesture in question, the gesture matching module 202 can effectively ignore it. In the case that the noise is not permissible, the gesture matching module 202 can conclude that the user has not performed the MTM gesture. Further, the gesture matching module 202 can make these determinations over the entire course of the user's interaction with the computing device 100 in making a gesture.

FIGS. 3-4 illustrate a non-MTM gesture performed by the user, followed by a MTM gesture. These figures therefore depict an example of how the IBSM 114 can interpret a fluid interleaving of MTM gestures with non-MTM gestures.

Beginning with FIG. 3, the user grasps the computing device 100 with two hands (302, 304) in a landscape mode. The user then executes a zooming gesture to enlarge a graphical object 306 presented on a display surface 308 of the computing device 100. For example, the graphical object 306 may represent a portion of a digital picture that the user seeks to enlarge.

More generally, the target (e.g., object) of any MTM or non-MTM gesture described herein can represent any content that is presented in any form on the display surface 308 (and/or other surface) of the computing device 100, including image content, text context, hyperlink content, markup language content, code-related content, graphical content, control feature content (associated with control features presented on the display surface 308), and so on. In other cases, the user can make a gesture that is directed to a “blank” portion of the display surface 308, e.g., a portion that has no underlying information that is being displayed at the present time. In that case, the user may perform the gesture to instruct the computing device 100 to display an object in the blank portion, or to perform any other action with respect to the blank portion. In still other cases, the user can perform a gesture that invokes a command that does not affect any particular object or objects (as will be set forth below with respect to the example of FIG. 12).

With respect to the particular example of FIG. 3, to execute a zooming gesture, the user may apply his or her thumbs (310, 312) to the display surface 308. The user then moves his or her thumbs (310, 312) apart while maintaining contact with the display surface 308. More specifically, in this case, the user moves the thumbs (310, 312) from initial contact positions (314, 316) to final contact positions (318, 320). This enlarges the object 306. But the user can also move his or her thumbs (310, 312) together to shrink the object 306.

FIG. 4 shows the outcome of the zooming gesture described above. More specifically, the object 306 (shown in FIG. 3) has been enlarged to the object 306′ shown in FIG. 4. As explained above, a zooming gesture is a non-MTM gesture because the multi-touch contact established by the user with his or her thumbs (310, 312) is not accompanied by movement of the computing device 100 (or at least not significant movement). Further, the zooming gesture is a non-MTM gesture because the user moves his or her fingers on the display surface 308 to execute it, whereas most of the MTM gestures described herein are defined with respect to the static placement of fingers on the display surface 308. However, as explained in Section B, the IBSM 114 can also accommodate some spatial displacement of the user's fingers during the movement of the computing device 100.

Still referring to FIG. 4, the user now seamlessly transitions to a MTM gesture by rapidly moving the computing device 100 about at least one axis, as indicated by the arrow 402. The user performs this task while maintaining his or her thumbs (310, 312) on the display surface 308 of the touch input mechanism 108. In this particular example, the user has quickly tilted the computing device 100 away from him or her by an angle of about 15-30 degrees. But a tilting-type MTM gesture can be defined with respect to a tilting operation performed in any direction (e.g., including the case in which the user tilts the computing device 100 toward himself or herself, rather than away). Further, a tilting-type MTM gesture can be defined with respect to any angular displacement of the computing device 100, and/or any speed of movement of the computing device 100, and/or any other type of movement of the computing device 100 (including non-angular movement).

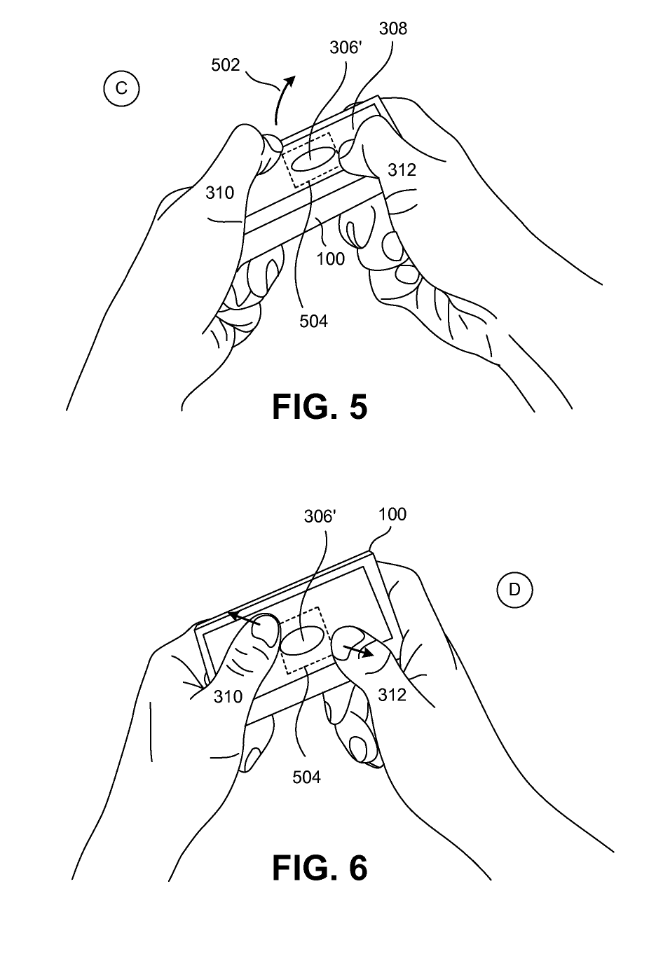

FIG. 5 shows the state of the computing device 100 following the full extent of the tilt movement initiated in FIG. 4. The user may then rotate the computing device 100 back to its original starting position, as indicated by arrow 502. At all times during this MTM gesture, the user maintains his or her thumbs (310, 312) on the display surface 308 of the touch input mechanism 108.

At a certain point in the course of making the MTM gesture, the IBSM 114 can detect that the user has made the MTM gesture in question. The point at which this detection occurs may depend on multiple factors, such as the manner in which the MTM gesture is defined, and the manner in which the MTM is performed by the user in a certain instance. In one case, the IBSM 114 can determine that the user has made the gesture at some point in the downward tilt of the computing device 100 (represented by arrow 402 of FIG. 4). In another case, the IBSM 114 can determine that the user has made the gesture at some point in the upward tilt of the computing device 100 (represented by arrow 502 of FIG. 5). In the former case, the MTM signature for the MTM gesture indicates that the gesture is produced when the user tilts the computing device 100 in a single direction. In the latter case, the MTM signature for the MTM gesture indicates that the gesture is produced when the user tilts the computing device 100 in a first direction and then in the opposite direction.

Upon detecting that the user has executed (or is currently executing) a MTM gesture, the IBSM 114 can perform behavior associated with the MTM gesture. A developer (and/or an end user) can associate any type of behavior with a gesture. In the merely illustrative case of FIG. 5, the tilting MTM gesture causes the IBSM 114 to select any object that is designated by the positions of the user's thumbs (310, 312).

More formally stated, the IBSM 114 generates an action space having a periphery defined by the positions of the user's thumbs (310, 312). In the example of FIG. 5, the IBSM 114 generates a rectangular action space having opposing corners defined by the positions of the user's thumbs (310, 312). Hence, the user can create an action space that encompasses a desired object by placing one thumb (e.g., thumb 310) above and to the left of the object, and the other thumb (e.g., thumb 312) below and to the right of the object. The user can then select the object or objects encompassed by the action space by executing whatever movement is associated with the MTM gesture.

In the particular example of FIG. 4, the user's thumb positions create a rectangular action space which encompasses the object 306′. By then tilting the computing device 100 in the direction of the arrow 402 of FIG. 4, the user can effectively select the object 306′. Other implementations can allow a user to establish action spaces having other shapes (besides rectangular shapes, such as circular shapes, oval shapes, non-rectangular polygonal shapes, etc.). In addition, other implementations can allow a user to demarcate these action spaces using different finger placement protocols compared to the protocol illustrated in FIGS. 3-6.

The IBSM 114 can optionally provide feedback that indicates that it has recognized a MTM gesture. For example, in FIG. 5, the IBSM 114 displays a border 504 that designates the periphery of the action space. The border 504 encompasses the object 306′, thereby visually informing the user that his or her gesture has successfully selected the object 306′. Alternatively, or in addition, the IBSM 114 can provide feedback by highlighting the action space and/or the encompassed object(s). Alternatively, or in addition, the IBSM 114 can provide auditory feedback, haptic feedback, etc.

FIG. 6 shows a state of the computing device 100 after the user has returned it to its initial position (by tilting it up towards the user). At this point, the user can optionally perform any operation pertaining to the action space defined by the MTM gesture. For example, the user can manipulate the size of the action space by executing a zooming gesture, e.g., by moving his or her thumbs (310, 312) farther apart or closer together. This may have the effect of increasing or decreasing the size of the object 306′ encompassed by the action space. Alternatively, or in addition, the user can perform any other action regarding the object 306′ that has been selected, such as by executing a command to delete the object 306′, transfer the object 306′ to a particular destination, change some visual and/or behavioral and/or status-related attribute(s) of the object 306′, and so on.

In the example set forth above, the IBSM 114 allows the user to perform manual follow-up operations to execute some action on the designated object 306′. Alternatively, or in addition, the IBSM 114 can automatically execute an action associated with the MTM gesture upon detecting the MTM gesture. For example, suppose the tilting gesture illustrated in FIGS. 3-6 has the end result of deleting any objects encompassed by an action space defined by the user's thumbs (310, 312). The IBSM 114 can automatically delete these objects when the user executes the tilt MTM gesture without soliciting further instruction from the user.

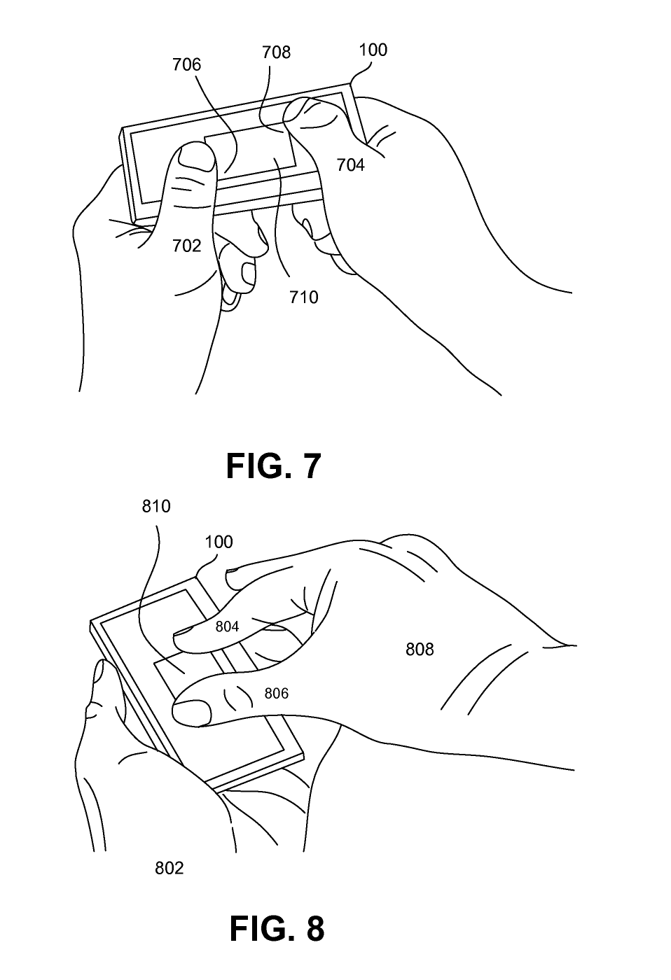

All aspects of the above-described scenario are representative, rather than limiting or exhaustive. For instance, FIGS. 7-12 illustrate representative variations of the example set forth above.

In FIG. 7, for instance, the user applies his or her thumbs (702, 704) to define the lower left corner 706 and upper right corner 708 of an action space 710. This differs from the example depicted in FIG. 4 in which the user applies his or her thumbs (310, 312) to define the upper left corner and lower right corner of the action space. In one case, the IBSM 114 nevertheless interprets the MTM gesture of FIG. 7 in the same manner as the MTM gesture of FIG. 4.

In another case, the IBSM 114 can define different MTM gestures that depend on different placements of fingers on the display surface of the touch input mechanism 108. For example, the IBSM 114 can interpret the framing thumb placement of FIG. 4, coupled with a tilting movement, as a request to delete the object 306′ encompassed by the action space. The IBSM 114 can interpret the framing thumb placement of FIG. 7, coupled with a tilting movement, as a request to place any object (not shown) that is encompassed by the action space in an archive store.

FIG. 8 shows a case in which a user holds the computing device 100 in one hand 802. The user then applies two fingers (804, 806) of the other hand 808 to define an action space 810 on the display surface of the touch input mechanism 108. More generally, the user can perform any MTM gesture by establishing at least two contacts with the display surface of the computing device 100 using any hand parts and/or other body parts. In addition, or alternatively, the user can perform any MTM gesture by establishing at least two contacts using any implement or implements (such a pen, stylus, etc.). For example, the user can establish one contact with a pen and another contact with a forefinger.

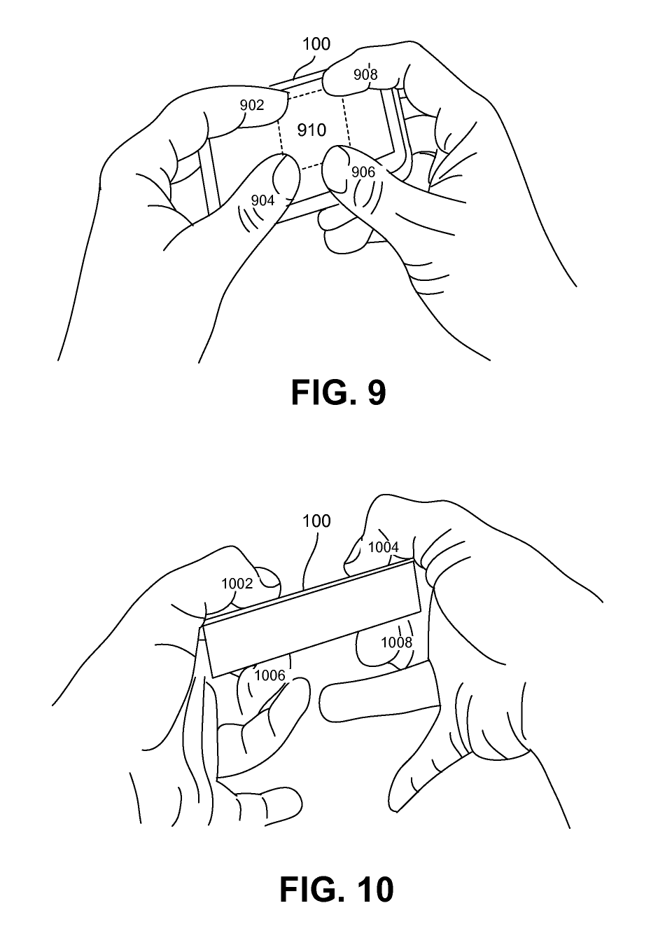

FIG. 9 shows an example in which the user uses four fingers (902, 904, 906, 908) to establish an action space 910. That is, the IBSM 114 interprets the finger positions as defining four corners of a polygonal-shaped action space 910 (which need not be rectangular). The IBSM 114 can interpret the MTM gesture of FIG. 9 in the same manner as the MTM gesture of FIG. 4. Alternatively, the IBSM 114 can interpret the four-finger MTM gesture of FIG. 9 as invoking a different action compared to the case of FIG. 4.

FIG. 10 shows an example that demonstrates that the touch input mechanism 108 can use any surfaces of the computing device 100 to receive input events, not just the front display surface of a touchscreen input mechanism. For example, in the case of FIG. 10, the back of the computing device 100 includes a touch pad input mechanism that a user may touch to provide input events. In this case, the user performs a particular MTM gesture by creating four contacts with the surface of the computing device 100, namely, two fingers (1002, 1004) on a front display surface of the computing device 100 and two fingers (1006, 1008) on a back surface of the computing device 100. The IBSM 114 can interpret the MTM gesture of FIG. 10 in the same manner as the MTM gesture of FIG. 4, or in a different manner.

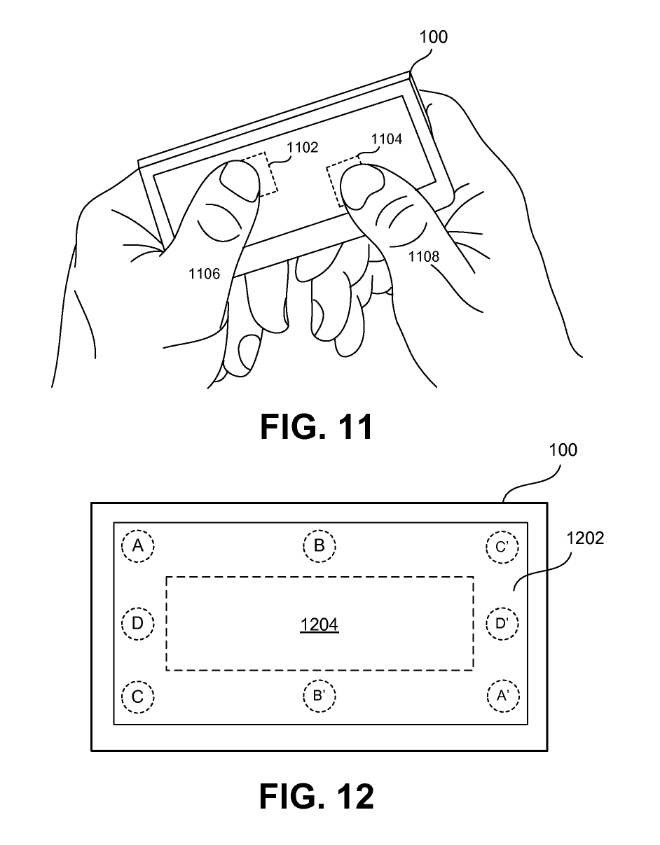

FIG. 11 shows a scenario in which the IBSM 114 presents graphical prompts (1102, 1104) on the display surface of the computing device 100. The prompts (1102, 1104) invite the user to place his or her thumbs (1106, 1108) onto the prompts (1102, 1104) and then perform the telltale device movement associated with a particular MTM gesture. This implementation differs from the preceding examples in which the no prompts are displayed. In those earlier examples, the user is free to define an action space on any portion of any surface of the computing device 100. In other words, the IBSM 114 implicitly enables the user to make MTM gestures and non-MTM gestures at any location, without expressly informing him or her of that capability.

The IBSM 114 can also simultaneously display prompts associated with different gestures. For example, the IBSM 114 can display a first pair of prompts on opposing corners of an action space, together with a second pair of prompts on the remaining corners of the action space. The first pair of prompts can solicit the user to perform a first MTM gesture associated with a first action, while the second pair of prompts can solicit the user to perform a second MTM gesture associated with a second action.

FIG. 12 shows an example in which the IBSM 114 devotes a particular region 1202 of the display surface that a user may touch to invoke different kinds of MTM gestures. Each gesture may invoke a different respective action. For example, the user can place a first finger on portion A of the region 1202 and a second finger on portion A′ of the region 1202 to invoke a first MTM gesture that is associated with a first action (that is, when the computing device 100 is then moved in a telltale manner, such as by tilting the computing device 100). Alternatively, the user can place a first finger on portion B of the region 1202 and a second finger on portion B′ of the region 1202 to invoke a second MTM gesture that is associated with a second action, and so on. In one case, the IBSM 114 can display graphical prompts associated with the various illustrated portions in FIG. 12. In another case, the IBSM 114 does not display prompts; here, the user may understand (based on independent written instruction, demonstration, ad hoc experimentation, or the like) that the user may perform various MTM gestures by touching the region 1202 in different ways.

In the example of FIG. 12, a MTM gesture may invoke an action which affects all of the objects that are presented in a display area 1204 enclosed by the region 1202. For example, the user can perform a MTM gesture to flip or scroll a page being presented on the display surface, or to delete all of the files identified on the display surface, etc. Alternatively, a MTM gesture can invoke some action that is not associated with any particular object or objects. For example, a user can perform a MTM gesture to perform any object-independent command, such as by increasing or decreasing volume, invoking or shutting down a particular application, and so on.

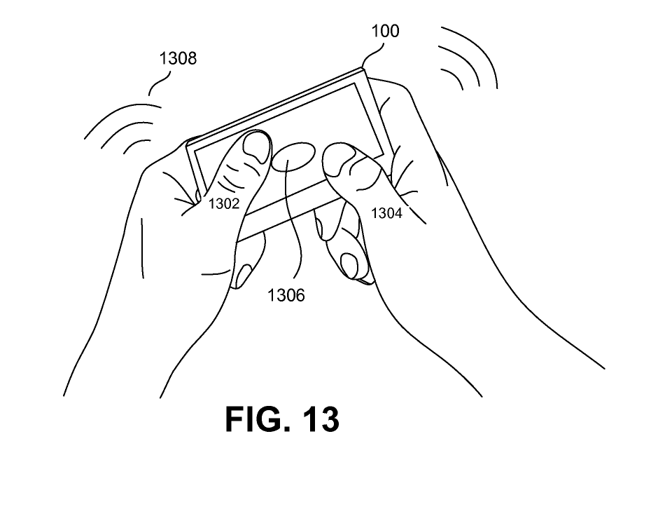

FIG. 13 shows an example where the user applies his or her thumbs (1302, 1304) to demarcate an action space in the same manner described above. That action space encompasses an object 1306. But instead of tilting the computing device 100, the user shakes the computing device 100 while maintaining his or her thumbs (1302, 1304) on the display surface. FIG. 13 depicts this shaking motion using the motion symbol 1308. In one case, the IBSM 114 can interpret the thus-performed MTM gesture in the same manner as the MTM gesture of FIG. 4. Alternatively, the IBSM 114 can interpret the gesture of FIG. 12 as invoking a different action compared to the MTM gesture of FIG. 4. More generally, the IBSM 114 can create different MTM gestures by choosing different types of motions. Each motion can invoke a different action when applied in conjunction with the same multi-touch contacts. Other types of motions that can be used to define MTM gestures include: a) sliding gestures where the user moves the computing device 100 in a plane, without rotating it; b) tapping gestures where the user vigorously taps on a surface of the computing device with a finger or implement, while framing an object with two other fingers; c) rapping gestures where the user taps the computing device 100 itself on some other object, such as a table top; d) vibratory gestures where the user applies vibratory motion to the computing device, and so on. These motions are mentioned by way of example, not limitation.

B. Illustrative Processes

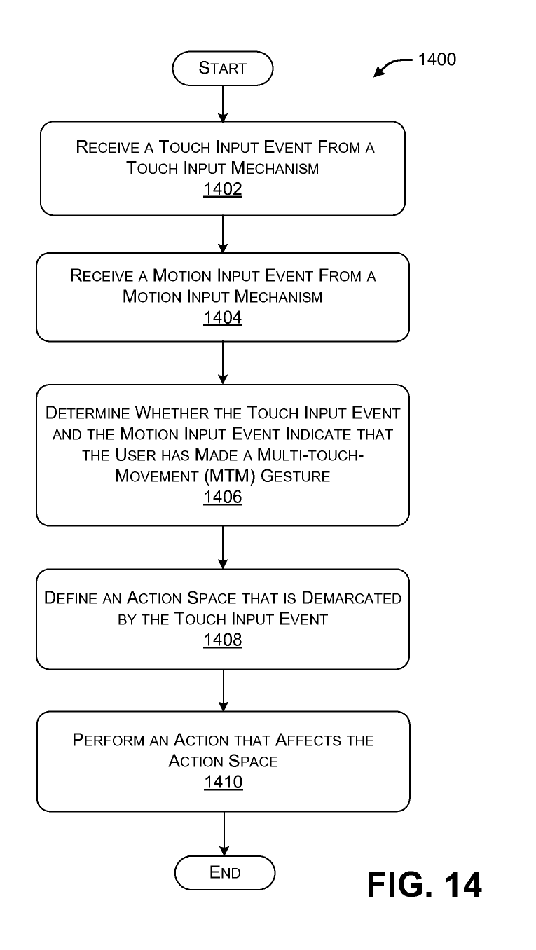

FIGS. 14-16 show procedures that explain one manner of operation of the interpretation and behavior selection module (IBSM) 114 of FIGS. 1 and 2. Since the principles underlying the operation of the IBSM 114 have already been described in Section A, certain operations will be addressed in summary fashion in this section.

Starting with FIG. 14, this figure shows an illustrative procedure 1400 that provides an overview of one manner of operation of the IBSM 114. In block 1402, the IBSM 114 receives a touch input event from the touch input mechanism 108 in response to contact made with a surface of the computing device 100. In block 1404, the IBSM 114 receives a movement input event from the movement input mechanism 110 in response to movement of the computing device 100. The touch input event and movement input event correspond to touch-related input information and movement-related input information (respectively) of any duration and any composition. In block 1406, the IBSM 114 determines whether the touch input event and the movement input event correspond to a multi-touch-movement (MTM) gesture. As explained in Section A, a user performs a MTM gesture by establishing two or more contacts with a surface of the touch input mechanism, in conjunction with moving the computing device in a prescribed manner.

In block 1408, the IBSM 114 can define an action space that is demarcated by the touch input event, e.g., by the positions of the contacts on the surface of the computing device 100. The placement of block 1408 in relation to the other operations is illustrative, not limiting. In one case, the IBSM 114 does in fact define the action space after the gesture has been detected. But in another case, the IBSM 114 can define the action space immediately after block 1402 (when the user applies the multi-touch contact to the surface of the computing device 100). In yet another case, the IBSM 114 can define the action space before the user even touches the computing device, e.g., as in the example of FIGS. 11 and 12.

In block 1410, the IBSM 114 performs any action with respect to the action space. For example, the IBSM 114 can identify at least one object that is encompassed by the action space and then perform any operation on that object, examples of which were provided in Section A.

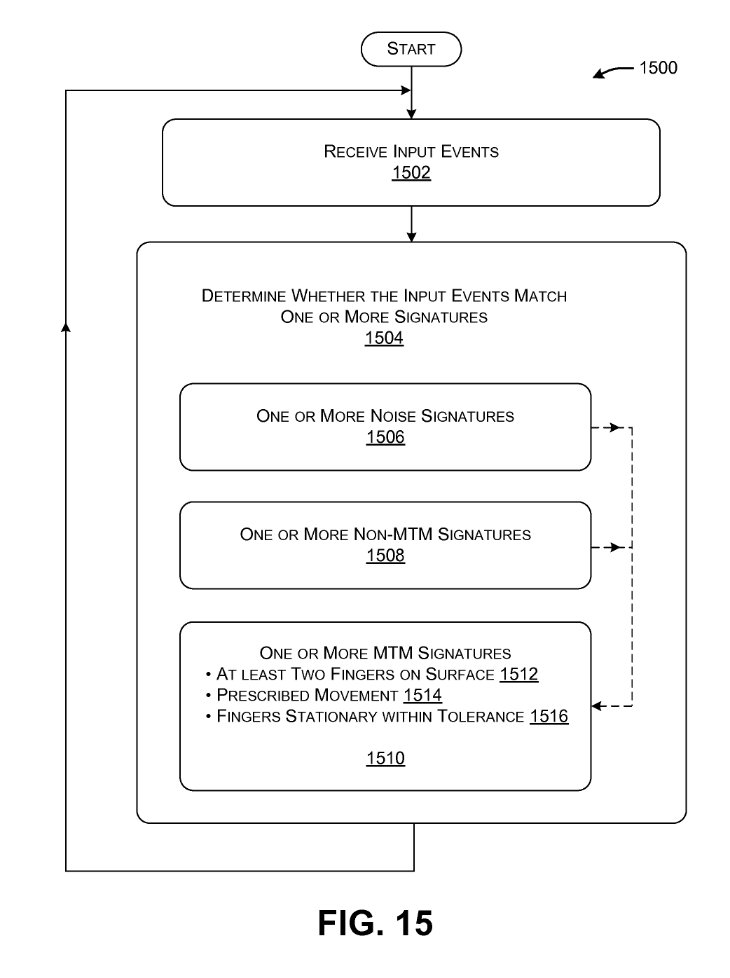

FIG. 15 shows a procedure 1500 that provides further details regarding the manner in which the IBSM 114 can detect a MTM gesture. In block 1502, the IBSM 114 receives input events. In block 1504, the IBSM 114 determines whether the input events match one or more signatures, including any of: one or more noise signatures 1506; one or more non-MTM signatures 1508 (e.g., a zoom signature, a pan signature, a scroll signature, etc.); and/or one or more MTM signatures 1510.

More specifically, an MTM signature may indicate that the user has performed a MTM gesture if: the user has applied at least two fingers (and/or other points of contact) onto a surface of the touch input mechanism 108 (as indicated by signature feature 1512); the user has moved the computing device in a prescribed manner associated with a MTM gesture (as indicated by signature feature 1514); and the user has not spatially displaced his or her fingers on the surface during the device movement (as indicated by signature feature 1516).

For example, the IBSM 114 can determine that the user has performed a particular type of MTM gesture if the user executes the contacts and movement illustrated in FIGS. 4 and 5. In another scenario, however, the IBSM 114 can determine that the user has slowly rotated the computing device 100 as an unintended (or intended) action in the course of making a non-MTM gesture. The IBSM 114 can prevent this action from being interpreted as a MTM gesture because the user has not tilted the computing device 100 in a quick enough fashion to constitute a MTM gesture (as defined by the MTM signature associated with this gesture). In addition, or alternatively, the user may have failed to tilt the computing device 100 through a specified minimum angular displacement associated with the MTM gesture (again, as defined by the MTM signature associated with this gesture).

As described in Section A, the IBSM 114 can also take into account noise when interpreting a user's actions. FIG. 15 illustrates this point by indicating that any MTM signature may make reference to (and/or incorporate) one or more noise signatures. Any MTM signature can also be defined in relation to one or more non-MTM signatures.

Consider the following scenarios in which the noise profile of the user's action may or may not play a role in the interpretation of a MTM gesture by the IBSM 114. In one case, assume that the user performs a zooming gesture by shifting the spatial positions of his or her fingers on the display surface of the computing device 100. Even if the user makes a movement that is associated with a MTM gesture (such as by tilting the computing device), the IBSM 114 will not interpret the zooming gesture as an MTM gesture, because the user has also displaced his or her fingers on the display surface.

But the above rule can be relaxed to varying extents in various circumstances. For example, the user's fingers may inadvertently move by a small amount even though the user is attempting to hold them still while executing the movement associated with a MTM gesture. To address this scenario, the IBSM 114 can permit spatial displacement of the user's fingers providing that this displacement is less than a prescribed threshold. A developer can define the displacement threshold(s) for different MTM gestures based on any gesture-specific set of considerations, such as the complexity of the gesture in question, the natural proclivity of the user's fingers to slip while performing the gesture, and so on. In addition, or alternatively, the IBSM 114 can allow each individual end user to provide preference information which defines the displacement-related permissiveness of a particular gesture in question. An MTM signature can formally express the above-described types of noise-related tolerances by making reference to (and/or incorporating) a particular noise signature that characterizes the above-described type of permissible displacement of the fingers during movement of the computing device 100.

In yet another case, a MTM gesture may be such that it is not readily mistaken for a non-MTM gesture. FIGS. 9 and 10 illustrate MTM gestures, for instance, that the IBSM 114 is unlikely to mistake for non-MTM gestures. In these cases, the MTM signature for such a gesture can express large spatial displacement thresholds or no movement thresholds. This allows a user to displace his or her fingers by a relatively large amount while making a MTM gesture, without diverging from the MTM gesture. That is, even with such large displacements, the IBSM 114 will still recognize the gesture as a MTM gesture. Indeed, in these cases, a developer or end user can even define a MTM gesture that incorporates spatial movement of fingers as an intended part thereof.

The IBSM 114 can also compare the input events with respect to motion associated with picking up and setting down the computing device 100, and/or other telltale non-input-related behavior. If the IBSM 114 detects that these noise characteristics are present, it will conclude that the user has not performed a MTM gesture, despite other evidence which indicates that a MTM gesture has been performed. A MTM gesture can formally express these types of disqualifying movements by making reference to (and/or incorporating) one or more appropriate noise signatures.

The IBSM 114 can compare input events against signatures using any analysis technology, such as by using a gesture-mapping table, a neural network engine, a statistical processing engine, an artificial intelligence engine, etc., or any combination thereof. In certain implementations, a developer can train a gesture recognition engine by presenting a training set of input events corresponding to different gestures, together with annotations which describe the nature of the gestures that the user was attempting to perform in each case. A training system then determines model parameters which map the gestures to appropriate gesture classifications.

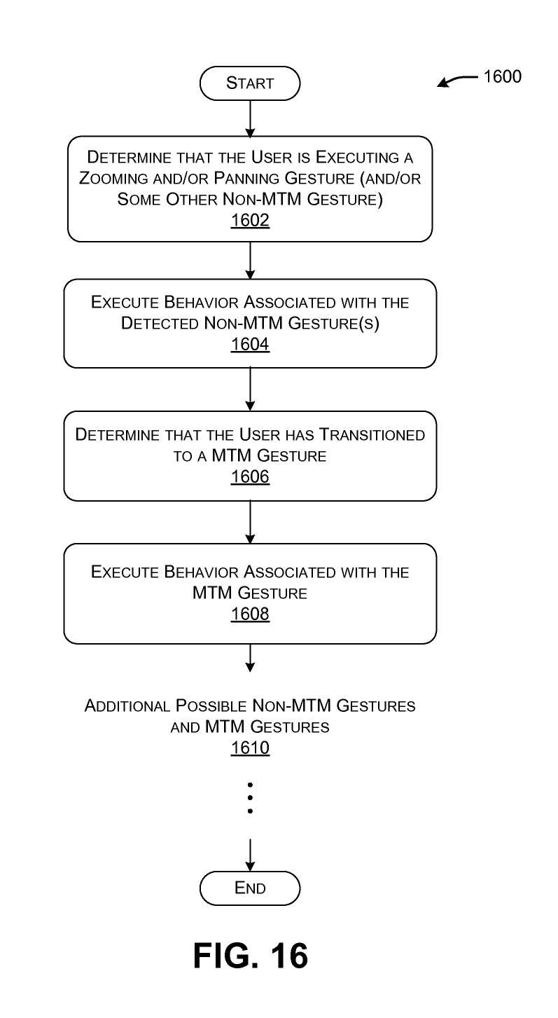

FIG. 16 shows a procedure which illustrates one manner in which the IBSM 114 can interpret a MTM gesture that is seamlessly integrated with a preceding and/or subsequent non-MTM gesture. In block 1602, the IBSM 114 determines that the user has optionally performed a MTM gesture, such as the zooming gesture shown in FIG. 3. In block 1604, the IBSM 114 executes the appropriate behavior associated with the non-MTM gesture. In block 1606, the IBSM 114 determines that the user has performed a MTM gesture. In block 1608, the IBSM 114 executes the appropriate behavior associated with the detected MTM gesture. Block 1610 indicates that the user may next perform one or more follow-up non-MTM gestures and/or one or more MTM gestures in any interleaved fashion.

C. Representative Computing Functionality

FIG. 17 sets forth illustrative computing functionality 1700 that can be used to implement any aspect of the functions described above. For example, the computing functionality 1700 can be used to implement any aspect of the IBSM 114. In one case, the computing functionality 1700 may correspond to any type of computing device that includes one or more processing devices. In all cases, the computing functionality 1700 represents one or more physical and tangible processing mechanisms.

The computing functionality 1700 can include volatile and non-volatile memory, such as RAM 1702 and ROM 1704, as well as one or more processing devices 1706 (e.g., one or more CPUs, and/or one or more GPUs, etc.). The computing functionality 1700 also optionally includes various media devices 1708, such as a hard disk module, an optical disk module, and so forth. The computing functionality 1700 can perform various operations identified above when the processing device(s) 1706 executes instructions that are maintained by memory (e.g., RAM 1702, ROM 1704, or elsewhere).

More generally, instructions and other information can be stored on any computer readable medium 1710, including, but not limited to, static memory storage devices, magnetic storage devices, optical storage devices, and so on. The term computer readable medium also encompasses plural storage devices. In all cases, the computer readable medium 1710 represents some form of physical and tangible entity.

The computing functionality 1700 also includes an input/output module 1712 for receiving various inputs (via input modules 1714), and for providing various outputs (via output modules). One particular output mechanism may include a presentation module 1716 and an associated graphical user interface (GUI) 1718. The computing functionality 1700 can also include one or more network interfaces 1720 for exchanging data with other devices via one or more communication conduits 1722. One or more communication buses 1724 communicatively couple the above-described components together.

The communication conduit(s) 1722 can be implemented in any manner, e.g., by a local area network, a wide area network (e.g., the Internet), etc., or any combination thereof. The communication conduit(s) 1722 can include any combination of hardwired links, wireless links, routers, gateway functionality, name servers, etc., governed by any protocol or combination of protocols.

Alternatively, or in addition, any of the functions described in Sections A and B can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In closing, functionality described herein can employ various mechanisms to ensure the privacy of user data maintained by the functionality. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have described various concepts in the context of illustrative challenges or problems. This manner of explanation does not constitute an admission that others have appreciated and/or articulated the challenges or problems in the manner specified herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, performed by a handheld computing device, for responding to input events, comprising:
receiving a touch input event from at least one touch input mechanism;
receiving a movement input event from at least one movement input mechanism in response to movement of the computing device;
determining whether the touch input event and the movement input event indicate that a user has performed a multi-touch-movement gesture,
where the multi-touch-movement gesture entails establishing two or more contacts with a surface of the touch input mechanism, in conjunction with moving the computing device in a prescribed manner;
defining an action space which is demarcated by said two or more contacts; and
performing an operation that affects the action space.

2. The method of claim 1, wherein said at least one touch input mechanism comprises a touchscreen interface mechanism having a display surface that is disposed on at least one surface of the computing device.

3. The method of claim 1, wherein said at least one movement input mechanism comprises at least one of:
an accelerometer device;
a gyroscope device; and
a magnetometer device.

4. The method of claim 1, wherein said two or more contacts define two opposing corners of the action space.

5. The method of claim 1, further comprising displaying at least one prompt that guides the user as to placement of a contact on the surface of the touch input mechanism.

6. The method of claim 1, wherein said determining comprises:
determining that the user has made a first multi-touch-movement gesture if the user contacts first regions of the surface of the touch input mechanism; and
determining that the user has made a second multi-touch-movement gesture if the user contacts second regions of the surface of the touch input mechanism, the first regions differing from the second regions, at least in part,
the first multi-touch-movement gesture invoking a first action and the second multi-touch-movement gesture invoking a second action, the first action being different than the second action.

7. The method of claim 6, wherein the first regions are associated with a first corner and a second corner of the action space, and the second regions are associated with a third corner and a fourth corner of the action space, wherein the first and second corners differ from the third and fourth corners at least in part.

8. The method of claim 1, wherein said determining also comprises:
determining a spatial shift of any of said two or more contacts during movement of the computing device; and
determining whether the spatial shift is below a prescribed threshold, and concluding that a user continues to perform the multi-touch-movement gesture if the spatial shift is below the prescribed threshold.

9. The method of claim 1, wherein said determining comprises:
determining whether movement of the computing device is indicative of handling the computing device by the user for a non-input-related purpose, to provide a handling input event; and
determining that the user has made the multi-touch-movement gesture based, in part, on the handling input event.

10. The method of claim 1, wherein the prescribed movement corresponds to a tilting movement of the computing device whereby the computing device is rotated about at least one axis from a starting position.

11. The method of claim 1, wherein the prescribed movement corresponds to a tilting movement of the computing device whereby the computing device is rotated about at least one axis from a starting position and then rotated back to the starting position.

12. The method of claim 1, wherein the prescribed movement corresponds to at least one of:
a prescribed vibratory movement;
a prescribed lateral displacement movement in a plane;
a prescribed shaking movement; and
a prescribed tapping movement.

13. The method of claim 1, wherein said determining also comprises:
determining that the user has made a first multi-touch-movement gesture if the user moves the computing device in a first prescribed manner; and
determining that the user has made a second multi-touch-movement gesture if the user moves the computing device is a second prescribed manner,
the first multi-touch-movement gesture invoking a first action and the second multi-touch-movement gesture invoking a second action, the first action being different than the second action.

14. The method of claim 1, further comprising selecting an object identified by said two or more contacts.

15. The method of claim 1, further comprising:
prior to detecting that the user has executed the multi-touch-movement gesture, detecting that a user has executed a preliminary gesture which involves contacting the surface of the touch input device with said two or more contacts,
wherein the user executes the multi-touch-movement gesture without removing said two or more contacts established by the preliminary gesture.

16. The method of claim 15, wherein the preliminary gesture is a zooming, scrolling, or panning gesture.

17. A computer readable storage medium for storing computer readable instructions, the computer readable instructions providing an interpretation and behavior selection module (IBSM), implemented by a handheld computing device, when the instructions are executed by one or more processing devices, the computer readable instructions comprising:
logic configured to receive a touch input event from at least one touch input mechanism;
logic configured to receive a movement input event from at least one movement input mechanism in response to movement of the computing device;
logic configured to determine whether the touch input event and the movement input event indicate that a user has made a multi-touch-movement gesture by:
determining that the user has applied at least two contacts on a surface of the touch input mechanism to demarcate an action space on the display surface; and
determining that the user has moved the computing device in a prescribed manner while touching the surface with said at least two contacts; and
logic configured to select an object associated with the action space in response to the multi-touch-movement gesture.

18. The computer readable storage medium of claim 17, wherein the prescribed movement corresponds to a tilting movement of the computing device whereby the computing device is rotated about at least one axis from a starting position.

19. An interpretation and behavior selection module, implemented by computing functionality, for interpreting user interaction with a handheld computing device, comprising:
a gesture mapping module configured to receive:
a touch input event from at least one touch input mechanism; and
a movement input event from at least one movement input mechanism that describes movement of the computing device; and
a data store for storing signatures associated with different indicative ways that a user can interact with the computing device, the signatures comprising at least:
a multi-touch-movement signature that provides information which characterizes a multi-touch-movement gesture that a user makes by touching a surface of the touch input mechanism with at least two contacts while moving the computing device in a prescribed manner; and
a handling movement signature that provides information which characterizes a manner in which the user handles the computing device for a non-input-related purpose,
the gesture matching module further configured to determine whether the user has made a multi-touch-movement gesture by comparing the touch input event and the movement input event against the signatures provided in the data store,
where at least two multi-touch-motion gestures invoke different respective actions depending on at least one of:
a manner in which the user touches the computing device, as reflected by the touch input event; and
a manner in which the user moves the computing device, as reflected by the movement input event.

20. An interpretation and behavior selection module of claim 19, wherein the prescribed movement associated with the multi-touch-movement signature corresponds to a tilting movement of the computing device whereby the computing device is rotated about at least one axis from a starting position.
